(19) United States
(12) Patent Application Publication
(10) Pub. No.: US 2010/0095826 A1
(43) Pub. Date: Apr. 22, 2010

(54) Cutter assembly for building materials having a non-planar profile

(76) Inventor: Don Sullivan, Arnprior (CA)

Correspondence Address: FLYNN THIEL BOUTELL & TANIS, P.C., 2026 RAMBLING ROAD, KALAMAZOO, MI, 49008-1631, US

(21) Appl. No.: 12/315,904

(22) Filed: Dec. 8, 2008

(30) Foreign Application Priority Data
Oct. 22, 2008 (CA) 2,640,991

(51) Int. Cl. B26D 1/04

(52) U.S. Cl. 83/697

(57) ABSTRACT

A cutter assembly is disclosed for use in cutting sheet building materials having a non-planar profile. The cutter assembly comprises a base portion, and a support plate mounted upon the base portion at an end thereof, for supporting the building materials during cutting thereof. The support plate and the base portion each have a predetermined profile shape that interfits with and matches the shape of the building materials. A cutting bar is pivotably connected to the base portion, and possesses a cutting blade attached thereto. The cutting bar is curved, and comprises first and second cutting protrusions which interfit with the predetermined profile shape of the support plate, for severing the building materials cleanly when the cutting bar is pulled downwardly.

The present invention relates to a cutter assembly for cutting or shearing desired lengths of sheet building materials having a non-planar profile.

### BACKGROUND OF THE INVENTION

In the construction industry, when desired lengths of sheet material having a non-planar profile, are required, such as during the home building process, these lengths are usually cut to size, conventionally, through the use of power tools, such as power saws. Examples of such materials that could be utilized are siding, soffit, facia board cover, flashing and the like, and, typically such materials comprise flat regions divided by channels and have an uneven sectional profile.

However, the use of power tools in cutting, in particular, soffit material, tends to leave the cut soffit material with a jagged, rough edge. Furthermore, in using such tools to cut this material, the shape of the material can be altered, so that when it is installed the cut pieces may not interfit properly. In addition, there can also be many job sites where power is not available, and an installer then has to resort to, for example, tin snips, to hand cut materials for installation on the building, with similar disadvantages from any unevenness in cutting.

Furthermore, in other cases, it is known in the art that the use of such power tools in cutting soffit material can also crumple or bend the material as it is being cut, thus destroying or severely damaging the material to the point that it is necessary to cut a new piece.

It is also known that the use of power tools such as power saws to cut metal material can create a “kickback” of the power tool when the material is being cut, which provides a potential danger to the person in cutting the material. Usually, such “kickback” will occur because the soffit material is usually cut on a flat surface, such as a table, but the soffit material itself is generally not flat along its entire length.

Accordingly, some portions of the soffit material, when it is laid flat on a surface to be cut, will be slightly raised above, and not supported by, the flat surface. As such, when the material is cut in the conventional manner outlined above there is a sizeable risk of buckling of the material, or “kickback” of the power tool used, when this material is cut. In addition, the use of power tools, such as power saws, to cut metal material in this manner can create situations where sharp, hot pieces of aluminum can be discharged into the face of the person cutting the material.

It would therefore be advantageous to have an improved cutter assembly for cutting desired lengths of sheet building materials safely and quickly, and which can provide the cut materials with a clean cut edge.

It would be further advantageous to have, in light of the above-noted risk of “kickback” in using power tools to cut sheet building materials, an improved, manually operated cutter assembly which can efficiently conform to the shape of the building materials, thus supporting the s materials as they are being cut without any “kickback” during the cutting process, and which is able to cut the materials without bending or damaging the materials. It would be further advantageous to have an improved cutter assembly which can be operated in a construction environment independently of a power source and provide a more effective cutting process than that which can obtained through the use of power tools.

### SUMMARY OF THE INVENTION

The present invention provides an improved cutter assembly for cutting desired lengths of sheet building materials safely and quickly, and which can provide the cut materials with a clean cut edge.

The present invention also provides an improved manually operated cutter assembly which substantially conforms to the shape of the sheet building materials, thus supporting the materials as they are being cut, and which is able to cut the materials without bending or damaging the materials.

According to a first broad aspect of an embodiment of the present invention, there is disclosed a cutter assembly for cutting sheet building materials having a non-planar profile comprising a base portion; a support plate mounted upon the base portion and positioned to receive and support the building materials during cutting thereof, the support plate and the base portion each having a predetermined profile shape for receiving, and corresponding to, a shape of the building materials; a cutting bar having a first end pivotably connected to an end of the base portion and a second free end; and a cutting blade attached along its length coterminous to the cutting bar and constructed and arranged to swing therewith, the cutting blade having a profile shape which interfits with the predetermined profile shape of the support plate for severing the building materials, and having a length greater than a length of the building materials in a cutting direction.

According to a second broad aspect of an embodiment of the present invention, there is disclosed a cutter assembly for cutting sheet building materials having a non-planar profile comprising a base portion; a support plate mounted upon the base portion and positioned to receive and support the building materials during cutting thereof, the support plate and the base portion each correspondingly having a generally U-shaped notch in a middle portion thereof and recessed grooves on a top and bottom end thereof, so as to form a predetermined profile shape for receiving, and corresponding to, a shape of the building materials; a cutting bar having a first end pivotably connected to an end of the base portion, and a second free end having a handle mounted thereon; and a cutting blade attached along its length coterminous to the cutting bar and constructed and arranged to swing therewith and having a length greater than a length of the building materials in a cutting direction, the cutting blade having a first cutting protrusion extending from a middle portion thereof and a second cutting protrusion towards an end portion thereof, the first and the second cutting protrusion forming a profile shape which interfits with the predetermined profile shape of the support plate for severing the building materials.

An important advantage of the present invention is that it provides an improved cutter assembly for cutting desired lengths of sheet building materials safely and quickly, and which can provide the cut building materials with a clean cut edge.

A still further advantage of the present invention is that it provides an improved cutter assembly which substantially conforms to the shape of the sheet building materials, thus supporting the materials as they are being cut, and which is able to cut the materials without bending or damaging the materials.

Yet another advantage of the present invention is that, in providing an improved cutter assembly which cuts the sheet building materials through manual operation rather than through the use of power tools, so that the risk of “kickback” is virtually eliminated.

### BRIEF DESCRIPTION OF THE DRAWINGS

The embodiments of the present invention will now be described by reference to the following figures, in which identical reference numerals in different figures indicate identical elements and in which:

FIG. 1 is a perspective view of an embodiment of the cutter assembly of the present invention, illustrating the soffit material to be cut;

FIG. 2 is an end view of an embodiment of the cutter assembly of the present invention, illustrating the soffit material to be cut;

FIG. 3 is a partial perspective view of an embodiment of the cutter assembly of the present invention, illustrating the soffit material in position to be cut; and

FIG. 4 is an end view of an embodiment of the cutter assembly of the present invention, illustrating the cutting blade and the soffit material in position to be cut.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

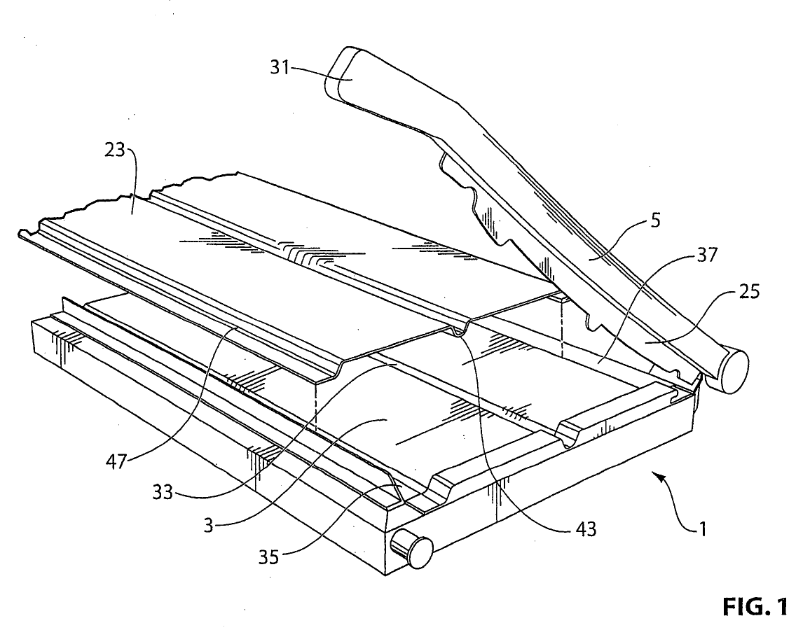

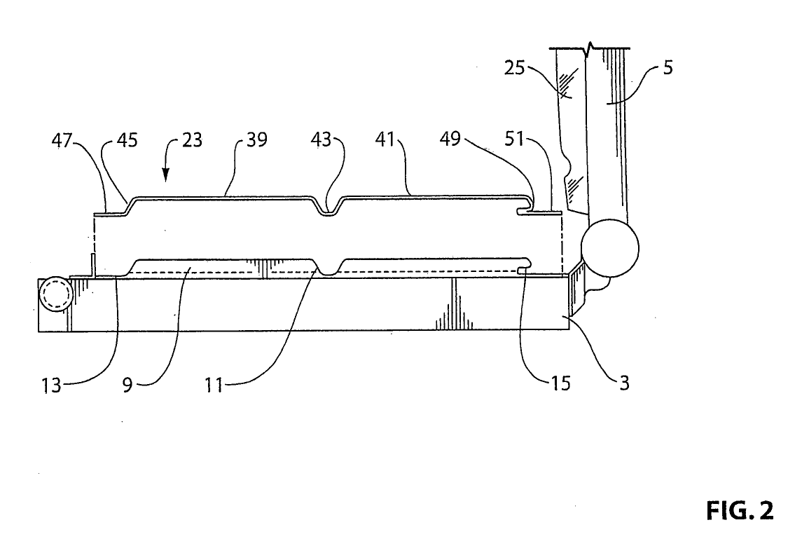

Referring to FIG. 1, there is shown a cutter assembly, shown generally at 1 in accordance with a first exemplary embodiment of the present invention, for cutting aluminum soffit, aluminum siding and plastic soffit and siding, facia board cover, flashing and the like. With reference to FIGS. 1 and 2, an indeterminate length of aluminum soffit 23, such as that which can be cut by the present invention, is provided having an irregular shaped section consisting of two raised panels 39 and 41 with an intermediate longitudinally extending rib 43. One edge of the soffit 23 includes a step portion 45 with flange 47, the other edge of the soffit includes a folded over portion 49 with outwardly extending flange 51. When this type of section is cut, such as with power tools, the folded over portion 49, or indeed other areas of the soffit material, can become crumpled or crushed, thus destroying or severely damaging the material to the point that it can become necessary to cut an entirely new piece. With the soffit cutter assembly 1 of the present invention, such soffit material is readily cut without causing damage thereto.

In a preferred embodiment, and with reference to FIG. 1, the cutter assembly 1 will be made of a durable, machinable metal and essentially comprises a table-like structure having a base portion 3 with an upper working surface, though it will be readily apparent to one skilled in the art that other materials comprising the table structure could be utilized. The base portion 3 may be mounted upon another support surface, such as saw horses, or a table, by means of brackets (not shown) positioned on an underside of the base portion 3. In addition, in another embodiment, the cutter assembly 1 can be pivotally connected to an upright support surface (not shown), such as a wall or trailer, whereby the cutter assembly 1 can be folded down for use.

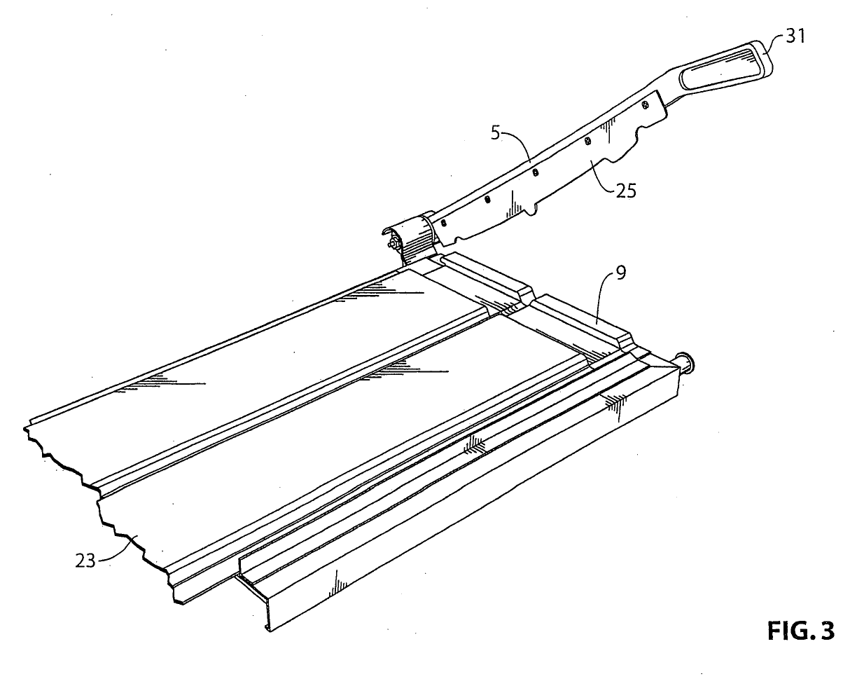

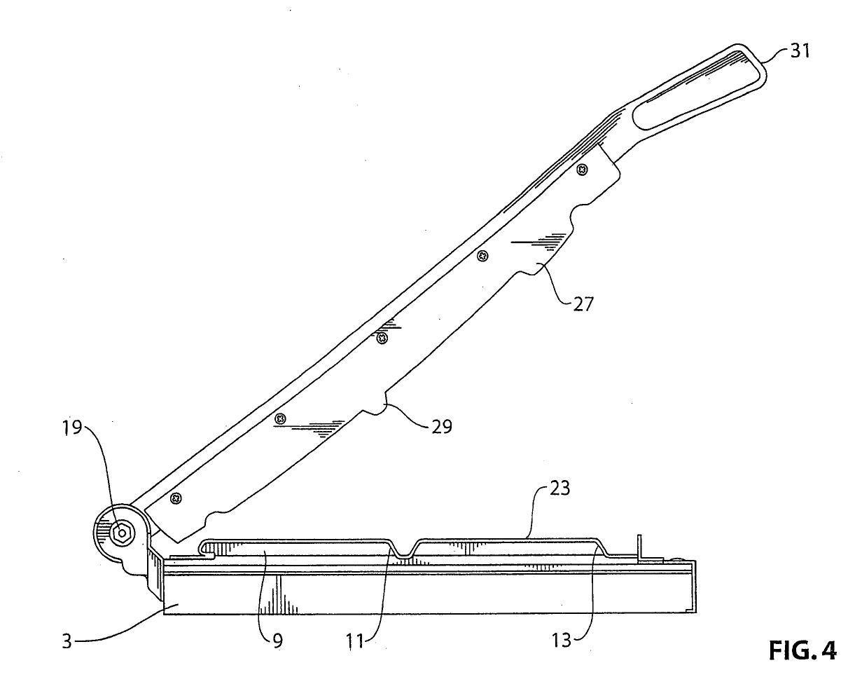

Referring to FIGS. 1 and 3, the cutter assembly 1 also preferably comprises a cutting bar 5 pivotably connected (as at 19 in FIG. 4) to the base portion 3, the cutting bar 5 having a handle 31 mounted at an end portion thereof. A cutting blade 25 is attached, preferably by screws, to the cutting bar 5, so as to swing therewith when the cutting bar 5 is utilized. It will, of course, be understood that variations as to the placement and attachment of the cutting bar 5 (and cutting blade 25 attached thereto) to the base portion 3 could be effected, as would be readily apparent to one skilled in the art.

With reference to FIGS. 2 and 3, a support plate 9 is mounted upon the base portion 3, preferably by screws, and is positioned to receive and support the soffit material 23 during the cutting thereof. Preferably, the support plate 9 is of a sufficient width so as to adequately support the soffit material 23 to be cut, and is positioned at a same end of the base portion 3 that the cutting bar 5 is pivotably connected to. In a preferred embodiment, as shown in FIG. 2, the support plate 9 comprises a generally U-shaped notch 11 in a middle portion thereof, a recessed groove 13 at one end, and another recessed groove having a lip portion 15 at an opposite end thereof, so as to form a predetermined profile shape for receiving, and corresponding to, a shape of the soffit material 23 shown in FIGS. 1 and 3; it being understood that the support plate could be varied to accommodate varying shapes and dimensions of other sheet building materials to be cut, as would be apparent to one skilled in this art.

With reference again to FIG. 1, the upper working surface of the base portion 3 preferably comprises a generally U-shaped notch 33 in a middle portion thereof and recessed grooves 35, 37 on either end thereof, so as to also form a predetermined profile shape for receiving, and corresponding to, a shape of the soffit material 23 shown in FIGS. 1 and 3. In a preferred embodiment, the U-shaped notch 33 of the base portion 3 will correspond substantially with the U-shaped notch 11 of the support plate 9, recessed groove 35 of the base portion 3 will correspond substantially to recessed groove 13 of the support plate 9, and recessed groove 37 will correspond substantially with lip portion 15 of the support plate 9.

As such, when the soffit material 23 is placed on the upper surface of the base portion 3 to be cut, as can be seen in FIG. 1, the flange portion 47 of the soffit material 23 will reside within groove 35, and the intermediate longitudinally extending rib 43 will reside within the U-shaped notch 33. Likewise, and with reference to FIG. 4, when the soffit material 23 is placed on the upper surface of the base portion 3 to be cut, a portion of the soffit material 23 will be positioned on top of the support plate 9, adjacent to the end of the base portion 3 that the cutting bar 5 is pivotably connected to. When so placed, a portion of the intermediate longitudinally extending rib 43 will also reside within the U-shaped notch 11 of the support plate 9, and outwardly extending flange 51 of the soffit material 23 will reside within recessed groove 37 of the base portion 3. Furthermore, folded over portion 49 will be retained substantially under lip portion 15 of the support plate 9.

According to a preferred embodiment of the invention, and with reference to FIG. 4, the cutting blade 25 is, preferably, curved or bevelled, and is shaped to include a first cutting protrusion 29 extending from a middle portion thereof and a second cutting protrusion 27 towards an end portion thereof.

In this manner, as the handle 31 of cutting bar 5 is pulled downwardly so that cutting blade 25 can cut the soffit material 23, the first cutting protrusion 29 and the second cutting protrusion 27 will interfit, respectively, into U-shaped notch 11 and recessed groove 13 of the support plate 9. Further, the first 29 and the second 27 cutting protrusions will also interfit, respectively, into and pierce the longitudinally extending rib 43 and flange 47 of the soffit material 23 as cutting blade 25 is moved downwardly in the process. In this manner, and in combination with the curvature of cutting blade 25, the soffit material 23 is not crushed or crumpled before it is cut, and a substantially clean cut is provided.

It will also be understood that, as noted previously, the shape and dimensions of the support plate and the cutting blade could be varied to accommodate varying shapes and dimensions of other sheet building materials to be cut, as would be apparent to one skilled in this art.

It will also be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The embodiments of the invention in which an exclusive property or privilege is claimed are defined as follows:

1. A cutter assembly for cutting sheet building materials having a non-planar profile comprising:
a base portion;
a support plate mounted upon the base portion and positioned to receive and support the building materials during cutting thereof, the support plate and the base portion each having a predetermined profile shape for receiving, and corresponding to, a shape of the building materials;
a cutting bar having a first end pivotably connected to an end of the base portion and a second free end; and
a cutting blade attached along its length coterminous to the cutting bar and constructed and arranged to swing therewith, the cutting blade having a profile shape which interfits with the predetermined profile shape of the support plate for severing the building materials, and having a length greater than a length of the building materials in a cutting direction.

2. The cutter assembly of claim 1, wherein the cutter assembly is constructed and arranged for pivotal connection to a wall surface.

3. The cutter assembly of claim 1, wherein the cutting blade is a curved blade.

4. The cutter assembly of claim 1, wherein the cutting blade is mounted on a handle.

5. The cutter assembly of claim 1, wherein the cutting blade further comprises a first cutting protrusion extending from a middle portion thereof and a second cutting protrusion towards an end portion thereof.

6. The cutter assembly of claim 5, wherein the first cutting protrusion and the second cutting protrusion interfits with the predetermined profile shape of the support plate for severing the building materials.

7. The cutter assembly of claim 1, wherein the support plate is positioned at a same end of the base portion that the cutting bar is pivotably connected to.

8. The cutter assembly of claim 1, wherein the support plate further comprises a generally U-shaped notch in a middle portion thereof, a recessed groove at a bottom end, and another recessed groove having an overhanging lip portion at a top end thereof, so as to form the predetermined profile shape corresponding with the shape of the building materials.

9. The cutter assembly of claim 1, wherein the base portion comprises a generally U-shaped notch in a middle portion thereof and recessed grooves on a top and bottom end thereof, so as to also form the predetermined profile shape corresponding with the shape of the building materials.

10. The cutter assembly of claim 1, wherein the base portion further comprises brackets on an underside thereof for mounting the cutter assembly to another surface.

11. A cutter assembly for cutting sheet building materials having a non-planar profile comprising:
a base portion;
a support plate mounted upon the base portion and positioned to receive and support the building materials during cutting thereof, the support plate and the base portion each correspondingly having a generally U-shaped notch in a middle portion thereof and recessed grooves on a top and bottom end thereof, so as to form a predetermined profile shape for receiving, and corresponding to, a shape of the building materials;
a cutting bar having a first end pivotably connected to an end of the base portion, and a second free end having a handle mounted thereon; and
a cutting blade attached along its length coterminous to the cutting bar and constructed and arranged to swing therewith and having a length greater than a length of the building materials in a cutting direction, the cutting blade having a first cutting protrusion extending from a middle portion thereof and a second cutting protrusion towards an end portion thereof, the first and the second cutting protrusion forming a profile shape which interfits with the predetermined profile shape of the support plate for severing the building materials.
